(19) United States
(12) Patent Application Publication
(10) Pub. No.: US 2008/0023031 A1
(43) Pub. Date: Jan. 31, 2008

(54) Cleaning Composition

(75) Inventors: Ken Edmund Kellar, Blue Ridge, VA (US); Jason Calhoun, Blackburg, VA (US)

Correspondence Address: NOVOZYMES NORTH AMERICA, INC., 500 FIFTH AVENUE, SUITE 1600, NEW YORK, NY, 10110, US

(73) Assignee: Novozymes Biologicals, Inc., Salem, VA (US)

(21) Appl. No.: 11/772,935

(22) Filed: Jul. 3, 2007

Related U.S. Application Data
(60) Provisional application No. 60/846,549, filed on Sep. 22, 2006.
(60) Provisional application No. 60/818,364, filed on Jul. 3, 2006.

(51) Int. Cl. B08B 7/00; C11D 9/26; C11D 9/32

(52) U.S. Cl. 134/6; 510/492

(57) ABSTRACT

The present invention relates to a cleaning composition suitable for cleaning stains on surfaces. The invention also relates to a kit for cleaning surfaces, especially stained surfaces, comprising a cleaning composition of the invention as a first component and an absorbent as a second component.

### CROSS-REFERENCE TO RELATED APPLICATIONS

This application claims priority or the benefit under 35 U.S.C. 119 of U.S. provisional application Nos. 60/818,364 and 60/846,549 filed Jul. 3, 2006 and Sep. 22, 2006, the contents of which are fully incorporated herein by reference.

### FIELD OF THE INVENTION

The present invention relates to cleaning compositions suitable for cleaning stains on surfaces. The invention also relates to a kit for cleaning surfaces, especially stained surfaces, comprising a cleaning composition of the invention as one component.

### BACKGROUND OF THE INVENTION

Surface cleaning compositions are commercially important products and have a wide field of utility in assisting in removal of dirt, grime, stains and soils from surfaces, including hard and soft surfaces.

US application no. 2006/0063689 concerns a concrete cleaner and preparation composition which includes urea hydrochloride, surfactant, water, and one or more glycol ethers.

U.S. Pat. No. 5,723,424 concerns a concrete cleaning mixture. The mixture consists of two components and each of the two components has two ingredients. The first ingredient of the first component consists of an all-purpose absorbent clay material while the second ingredient is a cat lifter or an attapolgite-type clay. Both of the ingredients of the first component are of a granular material. The second component also has two ingredients, the first is a Kaolin-type clay and the second ingredient is a finely ground day dust. The first component, when applied to the surface of a contaminated concrete, will loosen and break up the hardened oil or grease deposit while the ingredients of the second component, when applied to the concrete surface after the residue of the first component has been removed will absorb the oil from the pores and crevices of the concrete and apply a whitening effect to the concrete and will also seal the pores and the crevices of the concrete.

U.S. Pat. No. 5,951,784 concerns a hazardous ingredient free composition for cleaning automotive oils and grease stains from concrete.

WO 2005/049783 discloses an aqueous, dilutable hard surface cleaning composition comprising one or more anionic and/or nonionic surfactants, a thickener and an opacifying constituent.

U.S. Pat. No. 6,716,804-B2 discloses a cleaner/degreaser composition comprising a) a water soluble ethoxylate, b) a water insoluble ethoxylate, and c) a component selected from the group consisting of amphoteric surfactants and anionic surfactants (or couplers), or mixtures thereof.

Even though a huge number of cleaning compositions are known in the art there is nevertheless still a desire and need for especially cleaning compositions suitable for cleaning stained surfaces.

### SUMMARY OF THE INVENTION

The present invention relates to a cleaning composition that in diluted or undiluted form may be used for cleaning surfaces, especially stained surfaces, including hard surfaces such as concrete surfaces. The cleaning composition of the invention may also be used as active cleaning base/component in ready-to-use (or in-use) kits suitable for cleaning stained surfaces.

In the first aspect the invention relates to a cleaning composition comprising a solvent and a foam-generating component. The cleaning composition may in a preferred embodiment have the form of a foam.

A cleaning composition of the invention comprises a foam-generating component.

The foam-generating component may be a surfactant or any other foam-generating component. In a preferred embodiment the foam-generating component comprises an anionic surfactant or a combination of one or more anionic surfactants. Examples of foam-generating components include the ones selected from the group consisting of alkyl sulfates, alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, benzene sulfonates, alpha-olefin sulfonates, alkyl phosphates, phosphate ester, alkyl ether phosphates, acyl sarconsinates, and alkyl carboxylates.

More details on anionic surfactant are given below.

The cleaning composition of the invention may further contain one or more foam enhancement agents. Examples of suitable foam enhancement agents include the ones selected from the group consisting of primary alcohols, glycerol ethers, sulfolanyl ethers, glycerol esters, amides, sulfoanylamides, ethanolamides, diethanolamides, betaines, amine oxides, sulfobetaines, sulfoxides, alkyl amine salts, and alcohol ethoxylates.

The term “surfactant” means a molecule that belongs to a class of molecules having a hydrophilic group (or groups) and a hydrophobic group (or groups) that exhibit surface activity when the relative amounts of hydrophilic and hydrophobic parts are appropriate.

A “water soluble surfactant” means a surfactant that has solubility in water of more than 7% (on a weight/weight basis) at room temperature.

A “water insoluble surfactant” means a surfactant that has a solubility in water of less than 7% (on a weight/weight basis) at room temperature, preferably less than 2%, especially completely insoluble.

### BRIEF DESCRIPTION OF THE DRAWINGS

FIG. 1 shows photos of a cleaning study performed on an oil stain treated with a foaming solution concentrate of the invention applied as a liquid followed by an in-use dilution of the concentrate applied as a foam with added zeolite. Photo A: Before Cleaning; Photo B: Immediately after cleaning with foam concentrate, foaming solution, and zeolite; Photo C: 5 hours after cleaning

FIG. 2 shows photos from a test cleaning fresh used motor oil strains using a cleaning composition of the invention,

Step 1. Fresh used motor oil stains.

Step 2. Foam applied to stain.

Step 3. Zeolite/foam slurry.

Step 4, After brushing.

Step 5. After drying. A small pile of residual zeolite.

FIG. 3 shows a photo from a field trail using a cleaning kit of the invention applied to the center of an aged oil stain at a truck service station.

### DETAILED DESCRIPTION OF THE INVENTION

A cleaning composition of the invention may in diluted or undiluted form be used for cleaning surfaces, especially stained surfaces including hard surfaces such as concrete surfaces. The cleaning composition of the invention may also be used as active cleaning base/component in ready-to-use (or in-use) kits, such as two or more component kits, suitable for cleaning stained surfaces.

Cleaning Composition

In the first aspect the present invention relates to a cleaning composition comprising a solvent and a foam-generating component. The cleaning composition may be in the form of a foam or may be an aqueous cleaning composition that can easily be converted/transformed into a foam by using well known, e.g., mechanical, means.

The pH of a cleaning composition of the invention may vary dependent on the use, but may typically be in the range from 3-12, preferably 7-11, preferably in the range from 8-10, especially around pH 9.

The cleaning composition of the invention may be used for cleaning surfaces, preferably stained hard or soft surfaces.

Examples of contemplated hard surfaces include concrete, metal, glass, ceramic, wood, plastic, linoleum, and similar surfaces. Hard surfaces are found in toilets, shower stalls, bath-tubs, sinks, countertops, watts, floors and also include road surfaces.

Examples of contemplated soft surfaces include carpet, furniture, upholstery fabric, slippers, clothing, and other fibrous material surfaces.

A concentrated cleaning composition of the invention may, for instance, be diluted by the end-user in the ratio from 1:1 to 1:2000 (cleaning composition:water), preferably in a ratio of 1:1 to 1:250 (cleaning composition:water). Also, the end-user may, if necessary, add salts or buffer salts to the diluted composition to obtain the required/desired cleaning efficacy.

A cleaning composition of the invention is suitable for removing stains, such as grease and/or oily stains from hard or soft surfaces. Especially contemplated hard surfaces include oil stained surfaces, such as oil stained concrete surfaces. Such oil stained surfaces are found in, e.g., parking areas, floors in garages, roads and driveways. It is desired to clean such surfaces using minimal water so that none of the rinse water is intentionally allowed to run into, e.g., storm drains.

Foam

A cleaning composition of the invention may be delivered to the surface as a foam by using an appropriate mechanical device/apparatus. Such mechanical device/apparatus for generating foam are well known in the art. To facilitate foam formation, the formulation contains a proper combination of components and agents, since both foam formation and foam stability are desired. Typically, these requirements are met by incorporation of a foam generating component, typically one or more surfactants that allow for efficient foam formation, and the incorporation of foam enhancement agents that provide foam stability. Most surfactants wilt allow for some foam formation. However, preferred surfactants are those that 1) allow the foam to be formed efficiently or 2) are affected by foam enhancement agents.

Foam Generating Components

Preferred foam generating surfactants are anionic surfactants, especially with linear, or minimal branched, hydrocarbon chains such as surfactants selected from the group consisting of, alkyl sulfates, alkyl ether sulfates, alkyl amido ether sulfates, alkyl aryl polyether sulfates, alkyl aryl sulfates, alkyl aryl sulfonates, alkyl sulfonates, alkyl amide sulfonates, alkyl aryl sulfonates, benzene sulfonates, alpha-olefin sulfonates, alkyl phosphates, phosphate ester, alkyl ether phosphates, acyl sarconsinates, and alkyl carboxylates. Specifically contemplated foam-generating components include alkyl sulfates or alkyl sulfonates wherein the length of the hydrocarbon chain is from 8 to 16 carbon units, preferably with linear hydrocarbon chain lengths between 10 and 14 carbon units. Especially preferred are the anionic surfactants sodium decyl sulfate and/or sodium dodecyl sulfate. Commercially available anionic surfactants suitable as foam generating components include POLYSTEP B-25™ and/or STEPANOL WA-EXTRA™.

Foam Enhancement Agents

A cleaning composition of the invention may further contain one or more foam enhancement agents, Examples of suitable foam enhancement agents include the ones selected from the group consisting of primary alcohols, glycerol ethers, sulfolanyl ethers, glycerol esters, amides, sulfoanylamides, ethanolamides, diethanolamides, betaines, amine oxides, sulfobetaines, sulfoxides, alkyl amine salts, and alcohol ethoxylates.

The foam enhancement agent may be any foam enhancing agent including one or more of the following:
Primary alcohols: Non-limiting examples include linear alcohols with hydrocarbon lengths ranging from 8 carbons to 16 carbons such as n-octanol, n-nonyl alcohol, n-undecanol, n-tridecanol, n-decanol, n-dodecanol, and n-tetradecanol and n-hexadecanol.
   Glycerol ethers: Non-limiting examples include alpha-(n-octyl) glycerol ether, alpha-(n-decyl) glycerol ether, alpha-(n-dodecyl) glycerol ether.
   Sulfolanyl ethers, Non-limiting examples include decyl 3-sulfolanyl ether, hexadecyl 3-sulfolanyl ether.
   Glycerol esters: Non-limiting examples include glycerol monocaprate, glycerol monolaurate, pentaerythritol monocaprate, pentaerythritol monolaurate.
   Amides: Non-limiting examples include octanamide, decanamide, dodecanamde.
   Sulfoanylamides: Non-limiting example includes n-(3-sulfolanyl) lauramide.
   Ethanotamides: Non-limiting examples include n-(2-hydroxyethyl) lauraminide, coconut oil monoethanolamide.
   Diethanolamides: Non-limiting example includes coconut diethanolamide.
   Betaines: Non-limiting examples include cocomidopropyl betaine and lauryl betaine.
   Amine oxides. Non-limiting examples include lauramine oxide and myristylamine oxide.
   Sulfobetaines: Non-limiting example includes lauryl sulfobetaine.
   Sulfoxides,
   Alkyl amine salts. A non-limiting example is an amine salt that has an equal carbon chain length to the corresponding anionic surfactant, such as ⁺N(CH₃)₃CO₁₀H₂₁ to be used with (for example) C₁₀H₂₁SO³⁻.
Alcohol Ethoxylates: Non-limiting examples include alcohol ethoxylates having the formula: RO(CH₂CH₂O)nH, where R is the hydrocarbon chain length and n is the average number of moles of ethylene oxide. In one preferred embodiment the alcohol ethoxylate is a linear primary, secondary or branched alcohol ethoxylate where R has a chain length from C9 to C16 and n ranges from 0 to 6. In an especially preferred embodiment the water insoluble non-ionic surfactant is a linear primary, secondary or branched alcohol ethoxylate having the formula; RO(CH₂CH₂O)nH, wherein R has a chain length of C₉₋₁₁ and n is 2.5. In another preferred embodiment, R has a chain length of C12-13 and n is 3. In still another preferred embodiment R has a chain length of C12-13 and n is 1.

In a preferred embodiment the foam enhancement agent(s) is(are) insoluble in water.

Foam enhancement agents may be water insoluble nonionic surfactants. Preferred foam enhancement agents are water insoluble nonionic surfactants with hydrocarbon chains of 8 to 18 carbon units, linear or with minimal branching, such as primary alcohols, glycerol ethers, amides; N-polar substituted amides, and ethoxylated alcohols. The concept of combining an anionic surfactant with a water insoluble surfactant to generate stable foam is described in W. M. Sawyer and F. M. Fowkes, Interaction of Anionic Detergents and Certain Polar Aliphatic Compounds in Foams and Micelles, J. Phys. Chem. 62, (1958), 159-166, and in M. J. Schick and F. M. Fowkes, Foam Stabilizing Additives for Synthetic Detergents. Interaction of Additives and Detergents in Mixed Micelles, J. Phys. Chem. 61, (1957), 1062-1068. In a preferred specific embodiment sodium decyl sulfate is combined with TOMADOL™ 91-2.5 since it is similar in hydrocarbon chain length to TOMADOL™ 91-2.5. Another commercial product is BIO-SOFT™ N91-2.5.

Sodium decyl sulfate is preferred specifically because of the length and linearity of its hydrocarbon chain which is 10 carbon units. This length is preferred because it allows for more efficient foam formation in comparison to sulfates with longer carbon chain lengths, for example the commonly used sodium dodecyl sulfate. In a preferred embodiment the hydrocarbon chain length is between 6-16 carbon units, preferably 8-12 carbon units, especially 10 carbon units.

There are at least three reasons for the more efficient foam formation.

First, the shorter hydrocarbon chain makes the individual molecules of sodium decyl sulfate smaller, leading to more rapid diffusion of molecules from the bulk solution to the air/water interface where the foam is produced, thereby making foam production more efficient.

Second, the molecular weight of sodium decyl sulfate is lower because of the shorter hydrocarbon chain length, giving a higher concentration of molecules per unit volume for a given weight of material in comparison to a surfactant with a higher molecular weight. The higher concentration per unit volume makes the distance required to reach the air/water interface shorter, allowing for more efficient foam production.

Third, a hydrocarbon chain of 10 carbon units is long enough to give adequate foam stability during foam production, thereby allowing sufficient volume of foam to be produced, leading to good efficiency for foam production.

In an embodiment the cleaning composition of the invention comprises one or more anionic surfactants and one or more nonionic surfactants.

In an embodiment the ratio between anionic surfactant and nonionic surfactant is in the range from 10:1 to 110, preferably from 10:1 to 1:4, more preferably from 8:1 to 1:2, more preferably from 4:1 to 1.2. In a preferred embodiment the cleaning composition contains a water soluble anionic surfactant and/or a water insoluble anionic surfactant. Examples of suitable anionic surfactants are given above and further in the “Surfactants”-section below. Water soluble anionic surfactants are preferred. The nonionic surfactant may be a water insoluble nonionic surfactant or a water soluble nonionic surfactant, or a mixture thereof.

Examples of suitable nonionic surfactants are given in the “Surfactants”-section below. In an embodiment the ratio between anionic surfactant and water insoluble nonionic surfactant is in the range from 10:1 to 1:10, preferably from 10:1 to 1:4, more preferably from 8:1 to 1:2, more preferably from 4:1 to 1:2. In a preferred embodiment the ratio between water soluble nonionic surfactant and water insoluble nonionic surfactant is in the range from 10:1 to 1:10, preferably from 1:10 to 1:1, more preferably from 1:6 to 1:1. In an embodiment the ratio between anionic surfactant and total amount of nonionic surfactant is from 10:1 to 1:10, preferably from 10:1 to 1:1, more preferably from 6.1 to 1:1.

In an embodiment the cleaning composition of the invention comprises one or more anionic surfactants as foam generating component and one or more salts and/or buffer salts, wherein one or more salts or buffer salts are present in an amount from 0.1-10 wt-% of the cleaning composition, preferably 0.25%-2.5% wt-% of the cleaning composition, such as 0.5 to 10 wt.-%. In a preferred embodiment the anionic surfactant is water soluble. However, the anionic surfactant may also be water insoluble. Examples of suitable anionic surfactants are given below in the “Surfactants”-section. The cleaning composition may also further comprise one or more nonionic surfactants. The nonionic surfactant may preferably be water soluble, but may also be water insoluble. In an embodiment the cleaning composition comprises a combination of water soluble and water insoluble nonionic surfactants. Examples of suitable nonionic surfactant are given below in the “Surfactants”-section. In a preferred embodiment water soluble anionic surfactant(s) and water soluble nonionic surfactant(s) are present in a ratio between from 1:20 and 2:1, preferably from 1:12 to 1:1, especially from 1:10 to 1:5. The ratio between the anionic surfactant(s) and the nonionic surfactant(s) may in an embodiment of the invention be from 1:20 to 2:1, preferably from 1:12 to 1:1, especially from 1:10 to 1:5. Examples of suitable salts and/or buffer salts are given in the “Salts and Buffer Salts”-section below.

In an embodiment the foam generating component is an anionic surfactant. In an embodiment the cleaning composition comprises an anionic surfactant and a foam enhancement agent. In a preferred embodiment the ratio of anionic surfactant to foam enhancement agent is between 99.9:0.1 and 0.1:99.9. In the case where the foam enhancement agent is an alcohol ethoxylates, the ratio of anionic surfactant to foam enhancement agent, is between 90:10 and 10:90, preferably between 70:30 and 30:70, and more preferably between 60:40 and 40:60. In the case where the foam enhancement agent is a water-insoluble alcohol ethoxylate the ratio of anionic surfactant to foam enhancement agent is between 90:10 and 10:90, preferably between 70:30 and 30:70, and more preferably between 60:40 and 40:60. In the case where the foam enhancement agent is one or more water-insoluble primary alcohol, the ratio of anionic surfactant to foam enhancement agent is between 99.9:0.1 and 80:20. In the case where the foam enhancement agent is a monoethanolamide the ratio of anionic surfactant to foam enhancement agent is between 99.9:0.1 and 50:50, preferably between 90:10 and 70:30. In the case where the foam enhancement agent is a diethanolamide the ratio of anionic surfactant to foam enhancement agent is between 99.9:0.1 and 50:50, preferably between 90:10 and 70:30. In the case where the foam enhancement agent is an amide the ratio of anionic surfactant to foam enhancement agent is between 99.9:0.1 and 30:70, preferably between 90:10 and 70:30. In the case where the foam enhancement agent is a betaine, amine oxide, or sulfobetaine the ratio of anionic surfactant to foam enhancement agents is between 99.9:0.1 and 0.1:99.9, preferably between 95:5 and 5:95, and more preferably between 95:5 and 70:30.

In an embodiment the surfactants, including the foam-generating component(s) and the foam enhancement agent(s), constitute from 2.5%-15% (wow) of the total cleaning composition

Solvent

The cleaning composition of the invention is in a preferred embodiment free of organic solvent, but may in another embodiment contain one or more organic solvents, such as isopropyl alcohol. In a preferred embodiment the solvent is water.

Builder

In one embodiment the cleaning composition comprises one or more builders. Examples of suitable builders include carbonates, bicarbonates, phosphates, citric acid and citrates, borates, silicates, and chelates, such as EDTA (tetrasodium ethylenediaminetetraacetate), IDS (tetrasodium iminodisuccinate), and EDDS (trisodium ethylenediaminesuccinate)

Enzymes and Bacteria

The cleaning composition that produces foam may contain enzymes, bacteria, or bacterial spores along with an appropriate preservative system. In one embodiment the foam may be prepared as a concentrate that may be diluted for the “in-use” application. An advantage of having a foam concentrate is that it can be used for pretreating, e.g., difficult stains before applying a diluted “in-use” foam (cleaning composition). The concentrate may have a higher viscosity than the “in-use” composition, which keeps the liquid on the stain by slowing flow. An example of the use of a foam concentrate composition of the invention is given in Example 1 and an example of an “in-use” foam cleaning composition is given in Example 2. Both of these foam cleaning compositions were used in the cleaning studies, Example 3 and Example 4. The relative amounts of sodium decyl sulfate (obtained as POLYSTEP™ B-25, STEPAN) and TOMADOL 91-2.5 were determined according to the procedure outlined herein. For instance, a 50:50 ratio (as actives) gave a clear solution that was stable from 45° C. to freeze-thaw, but a 40:60 solution (sodium decyl sulfate/TOMADOL 91-2.5) remained turbid. Consequently, a composition with around 50150 ratio represents an example of an optimized solution because the solubility of the surfactants is minimized.

Salts and Buffer Salts

The cleaning composition may contain one or more salts and/or buffer salts. The salts or buffer salts may be any known inorganic salt, but is preferably a salt selected from the group consisting of alkali metal salts of nitrates, acetates, chlorides, bromides, iodides, sulfates, hydroxides, carbonates, hydrogen carbonates, (also called bicarbonates), phosphates, sulfides, and sulfites; ammonium salts of nitrates, acetates, chlorides, bromides, iodides, sulfates, hydroxides, carbonates, hydrogen carbonates (also called bicarbonates), phosphates, sulfides, and sulfites, alkaline earth metal salts of nitrates, chlorides, bromides, iodides, sulfates, sulfides, and hydrogen carbonates; manganese, iron, copper, and zinc salts of nitrates, acetates, chlorides, bromides, iodides, and sulfates, citrates and borates.

Especially contemplated are carbonates or bicarbonates, in particular selected from the group consisting of sodium carbonate and sodium bicarbonate, or a mixture thereof. In a specific embodiment the ratio between sodium carbonate and sodium bicarbonate is between 1:10 to 10:1.

The total amount of salts and/or buffer salts is preferably between 0.8 to 8 wt. %, preferably 1-5 wt. %, more preferably around 2 wt. % of the final in-use cleaning composition.

In another embodiment the salts and/or buffer salts constitutes from 0.1-10 wt-% of the cleaning composition, preferably 0.25%-2.5% wt-% of the cleaning composition.

Other Components

A cleaning composition of the invention may further include other components, typically ingredients conventionally used in composition suitable for cleaning surfaces. However, the ingredients may depend on the surface to be cleaned.

In case the surface is a hard surface, such as concrete, a corrosion inhibitor may be added.

For all cleaners, preservatives such as biocides, including NIPACIDE™, and chelating agents, including agents for controlling the hardness of water, such as EDTA, may be included.

Surfactants

A cleaning composition of the invention may include one or more anionic surfactants and/or one or more nonionic surfactants. This section provides a number of examples of surfactants.

Anionic Surfactants

The anionic surfactant(s) may be either water soluble or water insoluble. Water soluble anionic surfactants are preferred.

Examples of suitable water soluble anionic surfactants include those selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alphaolefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-n-alkyltaurates, and alkyl carboxylates.

In an embodiment the alkyl sulfate is a sodium, potassium, ammonium, ethanolamine, or magnesium salt, preferably with a carbon chain length from 6 units to 20 units. In a preferred specific embodiment the alkyl sulfate is sodium dodecyl sulfate (sodium lauryl sulfate) or sodium decyl sulfate.

In an embodiment the sulfated ethoxylate of fatty alcohol is a sodium, potassium, ammonium, ethanolamine, or magnesium salt, preferably with 1 to 6 oxyethylene groups and having a carbon chain length with from 6 to 20 units. In a preferred specific embodiment the sulfated ethoxylate of fatty alcohol is sodium laureth sulfate (sodium lauryl ether sulfate).

In an embodiment the alkyl sulfonate is linear or branched and is a sodium, potassium, ammonium, or magnesium salt, with a carbon chain length from 6 to 20 units. In a specific preferred embodiment the alkyl sulfonate is sodium octyl sulfonate. Sodium octyl sulfonate is preferred according to the invention mainly for two reasons. First, it is a small surfactant that is powdery and non-sticky. This allows a powdery, non-sticky residue to form upon evaporation of the cleaning composition of the invention. A powdery, non-sticky residue is less likely to attract dirt and cause rapid re-soiling of the cleaned area of, e.g., carpet. Second, it is preferred ac cording to the invention to use a small-molecule hydrotrope typified by sodium xylene sulfonate, which is also used to provide a powdery, non-sticky residue when the liquid formulation evaporates. The reason sodium octyl sulfonate is preferred is that it provides surfactancy: significant surface and interfacial reduction, as well as having the ability to solubilize material via micelle formation.

In an embodiment the alkyl benzene sulfonate is linear or branched and is a sodium, potassium, ammonium, or magnesium salt, with a carbon chain length (attached to benzene ring) from 6 units to 20 units. In a preferred specific embodiment alkyl benzene sulfonate is sodium dodecyl benzene sulfonate.

In a preferred embodiment the alpha-olefin sulfonate is a sodium, potassium, ammonium, or magnesium salt, having a carbon chain length (attached to benzene ring) from 6 to 20 units.

In a preferred embodiment the sulfosuccinate is a sodium, potassium, or ammonium salt, with a carbon chain length from 4 to 16 units. In a preferred specific embodiment the sulfosuccinate is disodium octyl sulfosuccinate.

In a preferred embodiment the alkyl diphenyloxide sulfonate is a sodium, potassium, or ammonium salt, with a carbon chain length from 6 to 22 units.

In a preferred embodiment the alkyl naphthalene sulfonate is a sodium, potassium, or ammonium salt, with a carbon chain length from 0 to 10 units, in a specific preferred embodiment the alkyl naphthalene sulfonate is sodium butyl naphthalene sulfonate.

In a preferred embodiment the ethoxylated sulfosuccinate is a sodium, potassium, or ammonium salt, with a carbon chain length from 6 to 20 units and having 1 to 6 oxyethylene groups, in a preferred specific embodiment the ethoxylated sulfosuccinate is 3 more ethoxylated sodium lauryl sulfosuccinate.

In a preferred embodiment the phosphate ester is a sodium, potassium, or ammonium salt, with a carbon chain length from 6 to 22 units.

In a preferred embodiment the alkyl carboxylate is a sodium, potassium, or ammonium salt, with a carbon chain length from 6 to 22 units, in a preferred specific embodiment the alkyl carboxylate is sodium stearate.

In a preferred embodiment the N-acyl-n-alkyltaurate is a sodium, potassium, and ammonium, calcium, or magnesium salt, with a carbon chain length from 6 to 22 units.

In a preferred embodiment the N-alkyl sarcoside is a sodium, potassium, or ammonium salts, with a carbon chain length from 6 to 22 units. In a preferred specific embodiment the N-alkyl sarcoside is sodium lauroyl sarcoside.

In a preferred embodiment the benzene-, toluene-, xylene-, or cumene sulfonate is a sodium salt. In a preferred embodiment the lignin sulfonate has a molecular weight of 1000 to 20,000.

Nonionic Surfactants

A cleaning composition of the invention may comprise one or more nonionic surfactant, which may be either water insoluble or water soluble.

Water Insoluble Nonionic Surfactants

Water insoluble nonionic surfactants are more likely to adsorb or penetrate water insoluble stains (like ink or motor oil) than water soluble nonionic surfactants. The presence of a polar part tends to make insoluble stains more soluble in aqueous solution, thereby making the stains easier to remove. Therefore in an embodiment the insoluble surfactant include one or more polar parts. By extension, making the aqueous cleaning composition as insoluble in water as possible is believed to increase the partitioning or adsorption of at least the most insoluble surfactant components into the water insoluble stain, thereby enhancing cleaning efficacy. It should be noted, that although these molecules have very tow solubility in water, they all contain at least one polar part, meaning they have some tendency to at least associate with water.

Contemplated water insoluble surfactants include alkyl and aryl: glycerol ethers, glycol ethers, ethanolamides, sulfoanylamides, alcohols, amides, alcohol ethoxytates, glycerol esters, glycol esters, ethoxylates of glycerol ester and glycol esters, sugar-based alkyl polyglycosides, polyoxyethylenated fatty acids, alkanotamine condensates, alkanolamides, tertiary acetylenic glycols, polyoxyethylenated mercaptans, carboxylic acid esters, and polyoxyethylenated polyoxyproylene glycols. Also included are EO/PO block copolymers (EO is ethylene oxide, PO is propylene oxide), EO polymers and copolymers, polyamines, and polyvinylpynolidones.

In an embodiment of the invention the water insoluble nonionic surfactant is an ethoxylate. It is preferred to have a carbon chain length as small as possible in the hydrophobic region in order to obtain optimal cleaning. In a preferred embodiment the water insoluble nonionic surfactant is an alcohol ethoxylate.

Alcohol ethoxylates have the formula: RO(CH₂CH₂O)ₙH, where R is the hydrocarbon chain length and n is the average number of moles of ethylene oxide. In a preferred embodiment the alcohol ethoxylate is a linear primary, or secondary or branched alcohol ethoxylate where R has a chain length from C9 to C16 and n ranges from C to 5. In an especially preferred embodiment of the invention the water insoluble nonionic surfactant is a linear primary, or secondary or branched alcohol ethoxylate having the formula: RO(CH₂CH₂O)ₙH, wherein R has a chain length of C9-11 and n is 2.5.

Examples of commercially available water insoluble surfactants can be found in the following. One class is the alkyl polyglycosides (or APGs) that are derived from natural resources and therefore friendly to the environment. Another class includes glycol ethers, particularly those with low vapor pressure (less than 0.1 mm Hg at 20° C.) so that they are considered as “Low Vapor Pressure VOC” by the California Air Resources Board, and examples are given below.

Glycol Ethers

| | |
|---|---|
| DOWANOL ™ TPnB | Tripropylene Glycol n-Butyl Ether |
| DOWANOL ™ DPnB | Dipropylene Glycol n-Butyl Ether |
| DOWANOL ™ pph | Propylene Glycol Phenyl Ether |
| DOWANOL ™ Eph | Ethylene Glycol Phenyl Ether |
| Hexyl CELLOSOLVE ™ | Ethylene Glycol Hexyl Ether |
| Hexyl CARBITOL ™ | Diethylene Glycol Hexyl Ether |
| Butyl CARBITOL ™ Acetate | Diethylene Glycol n-Butyl Ether Acetate |

Alcohol Ethoxylates

| | Average Carbon | Average Ethoxylation |
|---|---|---|
| | Chain Length | Number |
| Tomadol ™ 91-2.5 | 9-11 | 2.5 |
| Alfonic ™ 1214GC-3 | 12-14 | 3 |
| Hetoxol ™ TD-3 | 13 | 3 |
| Tergitol ™ 15-S-3 | 12-14 | 3 |
| Bio-Soft ™ N23-3 | 12-13 | 3 |
| Bio-Soft ™ AE-1 | 12 | 1 |
| Bio-Soft ™ AE-2 | 12 | 2 |
| Bio-Soft ™ AE-3 | 12 | 3 |
| Bio-Soft ™ N1-3 | 11 | 3 |
| Bio-Soft ™ N91-2.5 | 9-11 | 2.5 |

For instance, of the above commercially available water insoluble surfactants TOMADOL 91-2.5 and BIO-SOFT N91-2.5 are preferred because the hydrophobic region contains only 9-11 carbon atoms. Therefore, they will diffuse to the interface the fastest and offer the best cleaning efficacy. However, dependent on the cleaning composition and the application there may be reasons for not using these surfactants. For example, it may be that the surfactant content has to be present in extremely low concentration, e.g., for environmental reasons. In such case, the “original” cleaning composition that the 810-SOFT N91-2.5 would be added to would likely not be very small, because very small surfactants have low critical micelle concentrations, and it is usually best if the surfactants can be present in a concentration above the critical micelle concentration. Consequently, the “original” cleaning composition would likely contain larger surfactants, with a higher number of carbon atoms in the hydrophobic region, to help ensure that the surfactant content is above the critical micelle concentration. In this case, 12-13 carbons are needed and BIO-SOFT™ N23-3 would be preferred over BIO-SOFT™ N 91-2.5.

Water Soluble Nonionic Surfactants

Water soluble nonionic surfactants typically have a higher ethylene oxide content in the hydrophilic region of the surfactant in comparison to water insoluble nonionic surfactants.

In a preferred embodiment the water soluble nonionic surfactant is a linear primary, or secondary or branched alcohol ethoxylate having the formula: RO(CH₂CH₂O)ₙH, wherein R is the hydrocarbon chain length and n is the average number of moles of ethylene oxide. In a preferred embodiment R is linear primary or branched secondary hydrocarbon chain length in the range from C9 to C16 and n ranges from 6 to 13. Especially preferred is the alcohol ethoxylate where R is linear C9-C11 hydrocarbon chain length, and n is 6.

Examples of commercially available water soluble nonionic alcohol ethoxylate surfactants include NEODOL™ 91-6, TOMADOL™ 91-6, or 810-SOFT™ N23-6.5.

TOMADOL™ 91-6 is a preferred water soluble nonionic surfactant for cleaning composition used for concrete cleaning. The reason is that it is a small surfactant with good interfacial tension lowering ability.

Combination of Nonionic Surfactants

Combination of commercially available nonionic surfactant pair include TOMADOL™ 91-2.5 (water insoluble) and TOMADOL™ 91-6 (water soluble), and BIO-SOFT™ N23-3 (water insoluble) and BIO-SOFT™ N23-6.5 (water soluble).

The reason that above mentioned combination are suitable according to the invention is mainly due to attaining a pair where the surface or interfacial tension is lowered. To expand, if a pair of surfactants is chosen, it is preferred that the lengths of the hydrocarbon chains are equal to attain maximum decrease in surface or interfacial tension to enhance cleaning efficacy. However, in general it is preferred to use the surfactant molecules as small as possible.

According to the present invention the total amount of surfactant in the cleaning composition may differ dependent on the cleaning composition and the use thereof. For instance, if the cleaning composition is for carpet spot remover the total amount of surfactants may be around 2 wt. %. However, if the “in-use” cleaning composition is a concentrated concrete cleaner the total surfactant amount may be significantly higher. Therefore, according to the invention the amount of total amount of surfactant may be as low as 0.5 wt. % or lower and as high at 90 wt. %. Therefore, in embodiments of the invention the total amount of surfactant may be between 0.5 and 50 wt %, or between 1 and 20 wt %, or between 1 and 5 wt %, or around 2 wt % of the cleaning composition,

Specific Cleaning Compositions

In a preferred embodiment of the invention the cleaning composition is formulated as follows.

| COMPONENT | PERCENT BY WEIGHT |
|---|---|
| Solvent | 50-95 |
| Anionic surfactant | 2.5-15 |
| Water insoluble nonionic surfactant | 2.5-15 |
| Buffer salts | 0.25-1 |
| Optionally other ingredients | 0.1-10 |

In a specific embodiment a cleaning composition of the invention the cleaning composition is formulated as follows,

| COMPONENT | PERCENT BY WEIGHT |
|---|---|
| Water | 69-96 |
| POLYSTEP B-25 | 3-15 |
| TOMADOL 91-2.5 | 1-5 |
| Optionally EDTA, 40% Solution | 0.1-1.0 |
| Optionally NIPACIDE ™ | 0.01-0.2 |
| Sodium Bicarbonate | 0.2-1.0 |
| Sodium Carbonate | 0.01-0.2 |

In another embodiment the cleaning composition is formulated as follows:

| COMPONENT | PERCENT BY WEIGHT |
|---|---|
| Water | 35-99 |
| POLYSTEP B-25 | 1.0-30 |
| TOMADOL 91-2.5 | 0.5-10 |
| EDTA, 40% Solution | 0-5 |
| NiPACIDE ™ | 0-0.2 |
| Sodium Bicarbonate | 0-10 |
| Sodium Carbonate | 0-10 |

In a specific embodiment of the invention the cleaning composition is formulated as follows:

| Component | % by Weight |
|---|---|
| Water | 80 |
| POLYSTEP B-25 | 13 |
| TOMADOL 91-2.5 | 5 |
| 40% EDTA Solution | 1 |
| Sodium Bicarbonate | 0.85 |
| Sodium Carbonate | 0.15 |

In a specific embodiment of the invention the cleaning composition is formulated as follows:

| COMPONENT | PERCENT BY WEIGHT |
|---|---|
| Water | 80 |
| POLYSTEP B-25 | 13 |
| TOMADOL 91-2.5 | 5 |
| EDTA, 40% Solution | 0.9 |
| NIPACIDE ™ | 0.1 |
| Sodium Bicarbonate | 0.85 |
| Sodium Carbonate | 0.15 |

In a specific embodiment of the invention the cleaning composition is formulated as follows:

| COMPONENT | PERCENT BY WEIGHT |
|---|---|
| Water | 84.702 |
| POLYSTEP B-25 | 9.868 |
| TOMADOL 91-2.5 | 3.750 |
| EDTA, 40% Solution | 0.800 |
| NIPACIDE ™ | 0.060 |
| PHOSPHORIC ACID, 75% | 0.070 |
| Sodium Bicarbonate | 0.638 |
| Sodium Carbonate | 0.113 |

It should be understood that the components indicated as trademarks may be replaced with corresponding products.

The cleaning composition of the invention may be used as a component in a kit as will be described below.

Kit

In one aspect the invention relates to a kit suitable for cleaning surfaces. A kit of the invention comprises two or more components. The kit may consist of two or more components adapted for mixing. In a preferred embodiment the kit of the invention is free of organic solvents, especially isopropyl alcohol. The preferred solvent is water. When using a kit of the invention no rinsing is necessary.

According to the invention the first component may be a cleaning composition, preferably a liquid, such as aqueous cleaning composition. In a preferred embodiment the cleaning composition is a cleaning composition of the invention. The first component may be in the form of a foam or a cleaning composition that easily can be converted/transformed into a foam.

Means for preparing foams are well know in the art.

According to the invention the second component may be one or more absorbents. In a preferred embodiment the second component is a solid component, comprising absorbent that may be selected from the group consisting of diatomite, sepiolite, attipulgite, bentolite, montmorillonite, zeolites, gypsum, silicas and silicates, sand, concrete-based absorbents, paper, and organic products including those in the forms of pillows and particulates. In a specific embodiment the solid component of the Cleaning Kit contained Natural Zeolite (Clinoptilite, Boulder Innovative Technologies, Boulder, Colo.).

In an embodiment the kit further comprises one or more kinds of bacteria spores and/or one or more enzyme activities. The bacteria spores and enzymes, respectively, may be part of the first component and/or second component or constitute, e.g., a third, fourth, fifth component, etc. In other words, the enzyme(s) may in one embodiment be comprised in the first component (cleaning composition) and the bacteria spores in the second component (absorbent). However, the bacteria spores and enzyme(s) may also be comprised together with the first component or the second component, or both the first and second component.

In a preferred embodiment the bacteria spores are dormant spores. In a preferred embodiment the bacteria spore(s) is(are) (a) strain(s) of the genus Bacillus or a mixture thereof. Various strains and mixtures of strains of Bacillus spores are well known in the art. Especially contemplated Bacillus spores are commercially available strain from, e.g., Novozymes Biologicals Inc., VA, USA.

In an embodiment the enzyme(s) is (are) selected from the group consisting of lipase, amylase, protease, and cellulase, or mixtures thereof.

The kit of the invention may be suitable for removal of grease and/or oily stains from hard or soft surfaces. A kit of the invention is preferably a “no-rinse” product, which means that no rinsing is needed after cleaning the surface in question.

Method of Applying a Kit of the Invention

In this aspect the invention relates to a method of applying a kit of the invention for cleaning surfaces, preferably hard and/or soft surfaces. The kit of the invention is especially suitable for cleaning oil or grease stained surfaces. However, it should be understood that other stained surfaces (or surfaces with stains) are also contemplated according to the invention.

Hard surfaces include concrete, metal, glass, ceramic, plastic, linoleum and similar Surfaces. Hard surfaces are found in toilets, shower stalls, bathtubs, sinks, countertops, walls, floors and also include road surfaces.

Soft surfaces include carpets, furniture, upholstery fabric, slippers, clothing and other fibrous materials.

In an embodiment the invention relates to a method of cleaning a stained surface using a cleaning composition or kit of the invention comprising the steps of:
i) apply the cleaning composition in the form of a foam to the stained surface
ii) allow the foam to stand for a period of time
iii) apply one or more absorbents to prepare a slurry on the stained surface
iv) remove the slurry.

In a preferred embodiment the cleaning composition is a cleaning composition of the invention as described above. In a preferred embodiment the cleaning composition in step ii) is left on the stained surface for between 0 minutes to 24 hours, preferably between 30 seconds to 1 hour, especially around between 30 seconds to 5 minutes. In a preferred embodiment the stained surface is scrubbed for a period of time after step iii). The scrubbing time is preferably between 0 seconds and 1 hour, preferably between 10 seconds and 20 minutes, especially around between 10 seconds and 5 minutes. The slurry in step iii) may be left until dry. The slurry in step iii) may be contacted to the stain by abrasion, such as by brushing or the like. In an optional embodiment the slurry in step iv) is removed when dry. After carrying out this method of the invention no rinsing is necessary.

In a preferred embodiment the method of the invention is carried out by following the following steps:
a) apply a cleaning composition in the form of a foam or a liquid to the stain to be removed,
b) allow the liquid or the foam to stand on the stain for a period of time,
c) apply a cleaning composition of the invention in the form of a foam to the stain to be removed a second time.
d) allow the foam to stand on the stain for a period of time,
e) scrub the foam for a period of time
f) apply one or more absorbents to prepare a slurry on the stain
g) remove the slurry.

The steps may be repeated as many times are necessary for adequate strain removal. The standing time and scrubbing period is as mentioned for the corresponding steps above.

In an embodiment the aqueous cleaning composition is a no-rinse foam cleaning composition. The no-rinse application is based on the presence of foam. The foam delivers surfactants, preferably biodegradable surfactants, and optionally builders (preferably environmentally-acceptable builders) to the surface to remove, e.g., the dirt oil and when brushed, acts additionally as a lifting agent to pull the oil out of and away from the surface, such as concrete. That means that when using, e.g., a no-rinse concrete cleaner of the invention no liquid gets into the storm drain. The foam also acts as a suspending agent to keep the displaced oil and dirt away from the surface, thereby avoiding any redeposition onto the surface. The foam, oil, and dirt may be removed in any suitable way. For instance, the foam, dirt, and oil combination may be swept away using a wet/dry vacuum cleaner that contains an absorbent material. The contents of the wet/dry vacuum cleaner can finally be disposed of without requiring any further rinsing. Further, an absorbent material (preferably environmentally acceptable absorbent) could be added directly to the foam, and the resulting dry solid could be swept up and disposed of. This latter option offers the advantage that the drying time could be controlled simply by adjusting the amount of absorbent added to the foam.

The addition of an absorbent material to the foam offers another potential advantage. If the absorbent material is small and abrasive it may enhance the cleaning performance of the foam. As an example, a zeolite may be small enough to enter into pores of surface, e.g., concrete, and hard enough to literally scrape oil from the surface, thereby acting as a cleaning agent as well as an absorbent material. An important advantage is that foam allows surfactant composition and optional builder to be delivered with the minimum amount of water.

Use of a Cleaning Composition or Kit of the Invention

In this aspect the invention relates to the use of a cleaning composition or kit of the invention for cleaning surfaces, preferably stained surfaces, including hard and/or soft surfaces.

Hard surfaces include concrete, metal, glass, ceramic, plastic, linoleum and similar Surfaces. Hard surfaces are found in toilets, shower stalls, bathtubs, sinks, countertops, walls, floors and also include road surfaces.

Soft surfaces include carpets, furniture, upholstery fabric, slippers, clothing and other fibrous materials.

The surface may in one embodiment be oil or grease stained surfaces.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

Various references are cited herein, the disclosures of which are incorporated by reference in their entireties.

Materials & Methods

Foam Enhancement Agent:

TOMADOL™ 91-2.5 from Tomah Products is an alcohol ethoxylate with an average carbon length of C9-11 having an average ethoxylation of 2.5

Foam Generating Component

Sodium octyl sulfonate, purchased as POLYSTEP B-25 (a formulation containing 38% sodium decyl sulfate) from Stepan Products, is a water soluble anionic surfactant.

Preservative

NIPACIDE™ BIT 20 is manufactured by Clariant Corporation.

Absorbents

For the cleaning studies (Example 3 and Example 4), a zeolite obtained from Boulder Innovations, Clinoptite SCN 14×40 Mesh, was used.

### EXAMPLES

### Example 1

### Foam Concentrate

The composition in Table 1 can be used “as-is” as a pretreatment to oil stains before a foam is applied.

TABLE 1

| Component | % by Weight | Purpose |
|---|---|---|
| Water | 80.04 | Solvent |
| POLYSTEP | 13.16 | Solution containing anionic surfactant, |
| B-25 | | also the foam-generating component |
| TOMADOL | 5.00 | Water-insoluble nonionic surfactant, |
| 91-2.5 | | also the foam-stabilizing component |
| 40% EDTA | 0.8 | Control of water hardness |
| Solution | | |
| Sodium | 0.85 | Buffer; minimize surfactant solubility; |
| Bicarbonate | | increase viscosity |
| Sodium | 0.15 | Buffer; minimize surfactant solubility; |
| Carbonate | | increase viscosity |

POLYSTEP B-25 (Stepan) has sodium decyl sulfate present as the anionic surfactant (38%). Note that the relative amounts of sodium decyl sulfate and TOMADOL™ 91-2.5 are 50/50.

### Example 2

### “In-Use” Foam Composition

The foam in Table 2 is an ‘in-use’ cleaning composition

TABLE 2

| Component | % by Weight |
|---|---|
| Water | 50 |
| Foam Concentrate from Example 1 | 50 |

### Example 3

### Cleaning Study

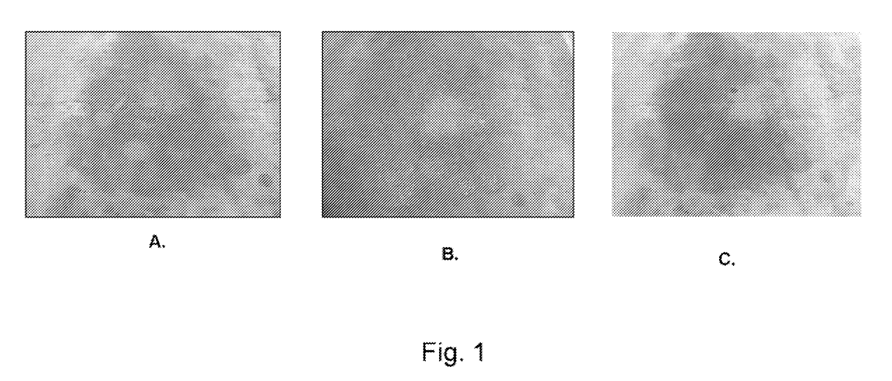

A cleaning study was performed at an automobile parts store in Salem, Va., USA, with a concrete parking lot, Part of an existing oil stain in a parking space was treated with the foam concentrate (Example 1) dispensed as a liquid, and allowed to sit for approximately 10 minutes. Foam was delivered to the pretreated area using the solution of Example 2 in combination with zeolite (absorbent). The foam was dispensed using a Kandoo Foaming Body Wash (Proctor & Gamble) bottle. The foam including the zeolite was scrubbed immediately for about 1 minute and then brushed off of the surface. The result of the test is shown in FIG. 1. Note that since this stain was heavy and not fresh, the concentrate (Example 1) was applied as a pretreatment.

### Example 4

### Cleaning of Fresh Used Motor Oil Stains

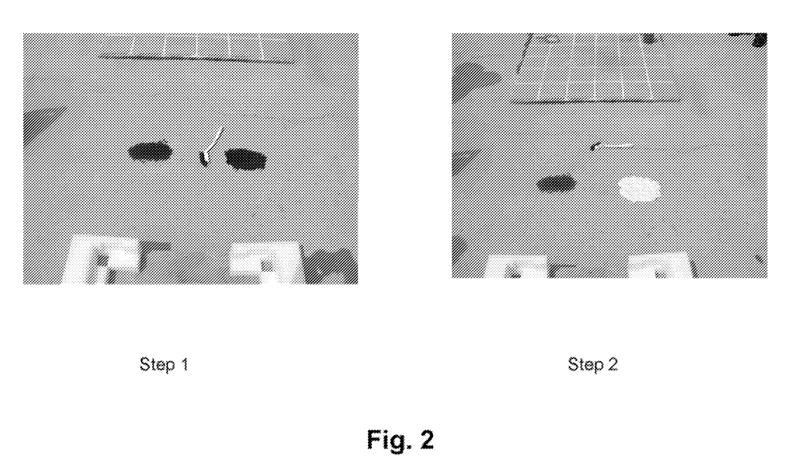

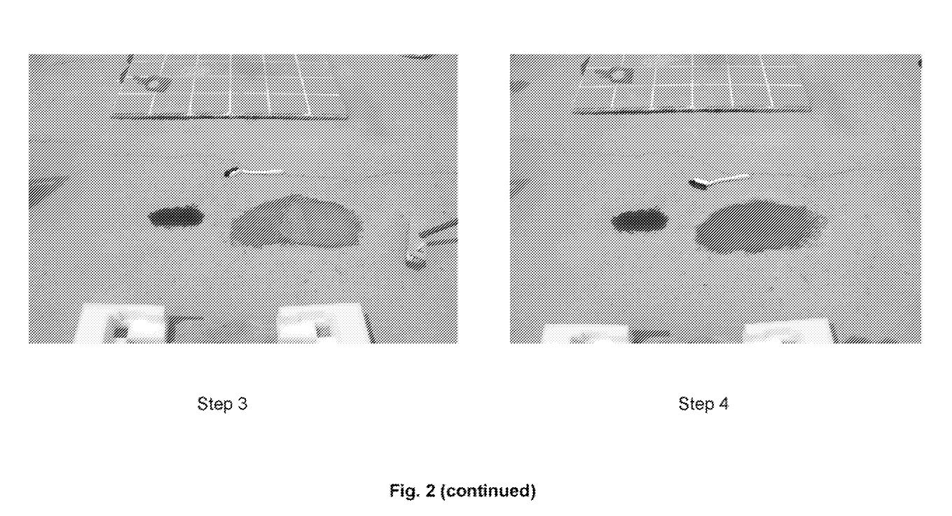

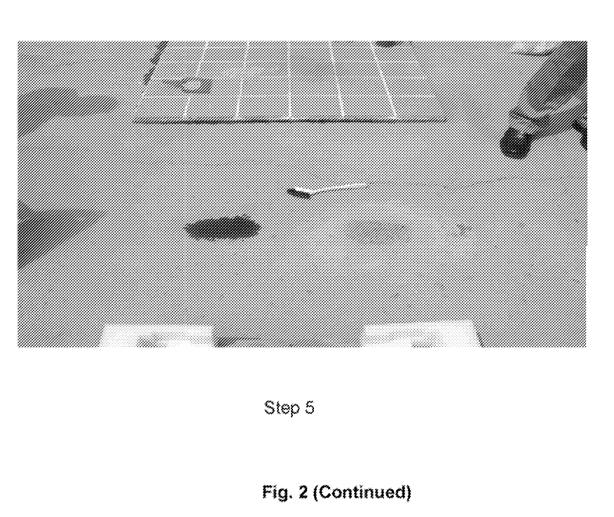

Cleaning of fresh used motor oil strain from a concrete loading dock was tested as follows:
1. Two fresh used motor stains were prepared and left to stand approximately 20 minutes.
2. The “in-use” formulation (see Example 2) was applied (Kandoo Foaming Body Wash bottle, Proctor & Gamble) to the stain on the left and left to sit for approximately 2 minutes.
3. Zeolites (absorbent), in a sufficient quantity to generate a dry residue, were applied to the foam and the slurry was brushed lightly for approximately 1 minute.
4. The slurry was left to dry (approximately 10 minutes) and the residual material was swept to the side of the stain.
5. Total cleaning time including drying was approximately 15 minutes.
   Step-by step photos can be seen in FIG. 2.

Note that since this stain was fresh, it was not necessary to use the concentrate (Example 1) as a pretreatment.

### Example 5

### Cleaning Kit Field Trial

A. Components of Cleaning Kit Used in Field Trial.

Liquid-Component

Cleaning composition of the liquid component of the Cleaning Kit used for the following field trial.

| COMPONENT | PERCENT BY WEIGHT |
|---|---|
| Water | 84.702 |
| POLYSTEP B-25 | 9.868 |
| TOMADOL 91-2.5 | 3.750 |
| EDTA, 40% Solution | 0.800 |
| NIPACIDE ™ | 0.060 |
| PHOSPHORIC ACID, 75% | 0.070 |
| Sodium Bicarbonate | 0.638 |
| Sodium Carbonate | 0.113 |

Solid Component

The solid component of the Cleaning Kit used for the field trial was Natural Zeolite (Clinoptilite, Boulder Innovative Technologies, Boulder, Colo.).

B. Cleaning Procedure

1. Using a Foam-iT™ Pump Up Foam Unit (Foam-iT™ Innovative Cleaning Equipment, Grand Rapids, Mich.), the liquid component was applied to the center of an aged oil stain at a truck service station.

2. The foam was allowed to dwelt on the stain for 10 minutes.

3. The foam was brushed using a stiff deck brush for about 30 seconds.

4. The absorbent, or solid component, was applied to the foam/oil mixture on the surface of the concrete.

5. The absorbent and the foam/oil mixture were brushed until a semi-solid residue was formed (about 30 seconds).

6. The semi-solid residue was brushed into a dustpan and removed.

7. The cleaned area was allowed to dry (about 10 minutes>).

To clean an area equal to about 1 square yard, approximately 150 grams of the liquid component and approximately 450 grams of the solid component were required.

C. Results

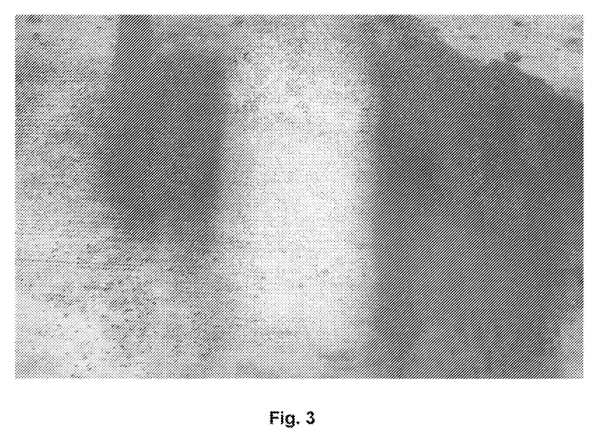

The results of the cleaning procedure are shown below in FIG. 3.

1-49. (canceled)

50. A cleaning composition comprising:
a) 50-95 wt-% solvent;
b) 2.5-15 wt-% anionic surfactant;
c) 2.5-15 wt.-% water insoluble nonionic surfactant; and
d) 0.25-1 wt-% buffer salt;
wherein
the anionic surfactant is selected from the group of linear alkyl sulfates with a hydrocarbon chain from 8 to 16 carbon units; linear alkyl sulfonates with a hydrocarbon chain from 8 to 16 carbon units, linear alkylbenzene sulfonates with a hydrocarbon chain from 6 to 20 hydrocarbon units.
ii. the water insoluble nonionic surfactant is selected from the group of primary, secondary or branched alcohol ethoxylates of the formula: RO(CH₂CH₂O)ₙH having a hydrocarbon chain (R) length from C9 to C16 and an average number of moles of ethylene oxide (n) in the range from 0 to 6.

51. The cleaning composition of claim 50, wherein the anionic surfactant has a hydrocarbon chain (R) from 8 to 12 carbon units.

52. The cleaning composition of claim 50, wherein the anionic surfactant is sodium decyl sulfate, sodium dodecyl sulfate, sodium octyl sulfonate, or sodium dodecylbenzene sulfonate.

53. The cleaning composition of claim 50, wherein the water insoluble nonionic surfactant is selected from the group of linear primary, secondary or branched alcohol ethoxytates wherein R is C9-11 and n is 2.5; R is C12-13 and n is 3; or R is C12-13 and n is 1.

54. The cleaning composition of claim 50, wherein the ratio between anionic surfactant and water insoluble nonionic surfactant is in the range from 4.1 to 1:2.

55. The cleaning composition of claim 50, wherein the buffer salt is sodium bicarbonate and/or sodium carbonate.

56. The cleaning composition of claim 55, wherein the ratio between sodium carbonate and sodium bicarbonate is between 1:10 and 10:1.

57. The cleaning composition of claim 50, wherein the solvent is water.

58. A kit for cleaning surfaces comprising
a first component comprising a cleaning composition of claim 50, and
a second component comprising one or more absorbents.

59. The kit of claim 58, wherein the absorbent is selected from the group consisting of diatomite, sepiolite, attipulgite, bentolite, montmorillonite, zeolites, gypsum, silicas and silicates, sand, concrete-based absorbents, paper, and organic products including those in the forms of pillows and particulates.

60. The kit of claim 58, further comprising bacteria spores and/or enzymes as part of the first component and/or second component or as a third component.

61. The kit of claim 60, wherein the enzyme(s) is (are) selected from the group consisting of a lipase, amylase, protease, and cellulase, or mixtures thereof.

62. The kit of claim 58, wherein the first component is a liquid cleaning composition to be applied in the form of a foam.

63. A method of cleaning stained hard surfaces using a kit of claim 58 comprising the steps of:
i) apply the cleaning composition in the form of a foam to the stained hard surface;
ii) allow the foam to stand for a period of time;
iii) apply one or more absorbents to prepare a slurry on the stained surface,
iv) remove the slurry.

64. The method of claim 63, wherein the cleaning composition in step ii) is left on the stained surface for between 0 minutes to 24 hours.

65. The method of claim 63, wherein the stained surface is scrubbed for a period of time after step ii) or iii).

66. The method of claim 63, wherein the slurry in step iii) is left until dry.

67. The method of claim 63, wherein the slurry in step iii) is contacted to the stain by abrasion.

68. The method of claim 63, wherein the slurry in step iv) is removed when dry.

69. The method of claim 63 comprising the steps of:
a) applying a cleaning composition in the form of a foam or a liquid to the stain to be removed,
b) allowing the liquid or the foam to stand on the stain for a period of time,
c) applying a cleaning composition in the form of a foam to the stain to be removed a second time.
d) allowing the foam to stand on the stain for a period of time,
e) scrubbing the foam for a period of time,
f) applying one or more absorbents to prepare a slurry on the stain, and
g) removing the slurry.

70. The method of claim 63, wherein the hard surface is selected from the group of concrete, metal, glass, ceramic, plastic, and linoleum.

71. The method of claim 63, wherein the stain is an oil or grease stain.
